(19) United States
(12) Patent Application Publication
(10) Pub. No.: US 2005/0083433 A1
(43) Pub. Date: Apr. 21, 2005

(54) Automated audio/video recording system

(76) Inventors: Colin Wishart, Montreal (CA); Gordon Wishart, Montreal (CA)

Correspondence Address: COLIN WISHART, 4557 SHERBROOKE, APT. 307, MONTREAL, QC, H3Z 1E8, CA

(21) Appl. No.: 10/968,651

(22) Filed: Oct. 18, 2004

(30) Foreign Application Priority Data
Oct. 20, 2003 (CA) 2445814

(51) Int. Cl. H04N 5/225

(52) U.S. Cl. 348/375

(57) ABSTRACT

This invention consists of a self-contained, weather resistant, moveable, automated video and audio recording vending system. The system provides a means for automatically recording an event after a token, coin or other monetary currency is inserted into the device.

This invention relates to an automated audio and video recording system whose operation is enabled upon insertion of a token, coin or other monetary currency.

While practicing or playing a sport or some other activity, it is sometimes useful to video record the event in order to later examine the video to look for flaws and ways to improve (e.g. reviewing your swing at a golf driving range), or simply to document the event. Today, someone could use a standard hand held video recorder to tape the event, but this requires a second person to operate the video recorder and the other to perform the activity being recorded. Alternately, someone could install a video recorder on a tripod, set it the appropriate distance away, and record himself. This requires the person to have the necessary video recording equipment and is willing to take the time to set it up at the appropriate location.

To simplify the process of recording an event not limited to, but especially at a golf driving range, an automated video recording system could be placed at the appropriate location to capture the event. The user would enable the recording system by inserting a token, coin(s) or other monetary currency into the system. The system would then automatically record for a pre-set amount of time. Upon completion of recording the event, the system would eject the medium upon which the event had been recorded (e.g. VHS tape). For example, this recording device could be installed at a golf driving range. Golfers would purchase tokens or insert coins into the device in order to enable the video recording function.

In drawings which illustrate embodiments of the invention,

FIGS. 1, 2, and 3 show the front, side and rear views of the system's enclosure respectively.

FIG. 4 is a block diagram showing how the various components interconnect within the enclosure.

FIG. 4 illustrates a video camera 1 and optionally an audio microphone 14 connected to a VCR 10. A control panel consisting of a coin/token mechanism 9, an electronic timer switch 15 and programmable infrared controller 16 accepts the coin or token input and trigger the VCR 10 to RECORD (after the user has also inserted their VHS tape into the VCR). After a preset amount of time (controlled by the electronic timer switch 15) a relay is switched which causes the infrared controller 16 to send the STOP and EJECT commands to the VCR 10. Note that other types of recording systems can be used in this device (e.g. DVD recorder). An optional on/off switch 17 allows the user to stop recording and eject their VHS tape before the preset time is complete. A rechargeable 12 VDC battery 13 powers the control panel, and a power inverter 12 converts the 12 VDC to 120 VAC to power the video camera and VCR. Depending on the country where it is used, the system can optionally be powered by other voltages, or other power sources (such as solar panels).

FIG. 1 illustrates the front view of the enclosure 6 that houses all of the components in the system. By housing all of the components in a lightweight plastic enclosure 6 with wheels on the bottom 7, the system can easily be transported from one location to another. Also, the plastic enclosure 6 is weather resistant, permitting the system to be used outdoors. The video camera 1 is housed inside of a plastic dome connected to a curved hollow pipe 2. The height of the pipe 2, angle of the camera 1 and camera optics determine the size of the field of view being recorder by the camera 1. The wiring from the camera 1 runs through the hollow pipe 2 into the main body of the enclosure. A transparent hinged plastic flap 3 on the front of the enclosure 6 allows the user access to the VCR input 4, and the token or coin mechanism input 5 and protects the user input section of the system.

FIG. 2 illustrates the side view of the enclosure 6 and the back door 8 that provides access to the components inside the system.

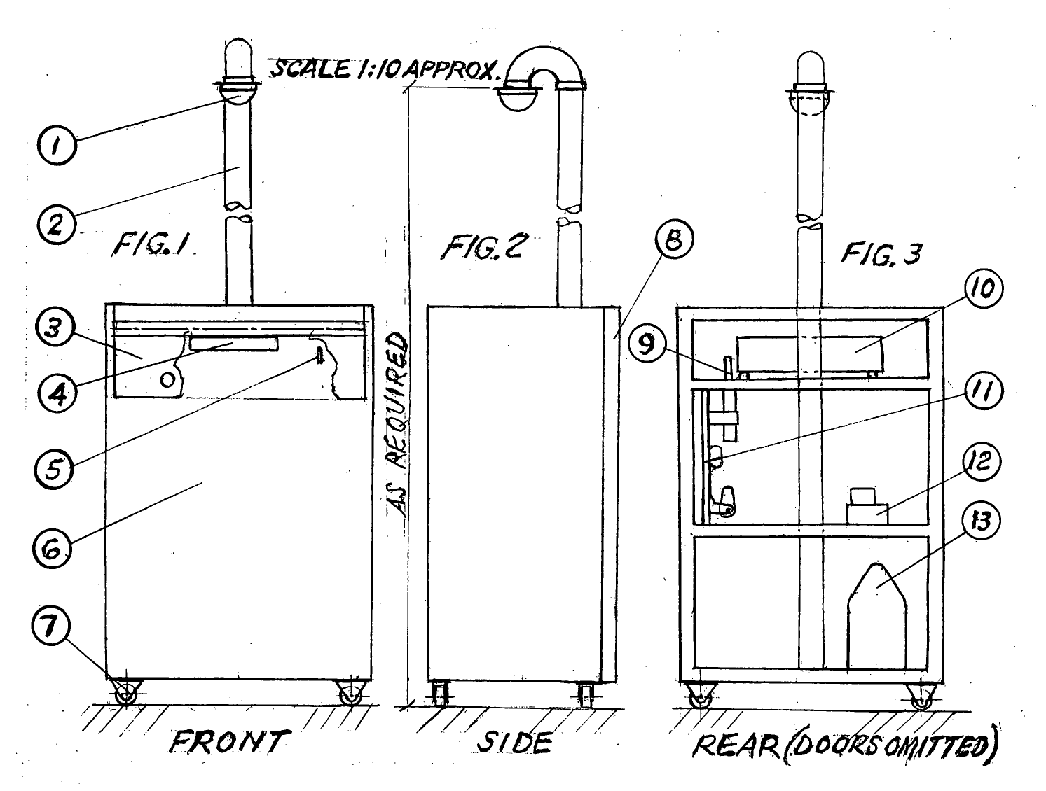

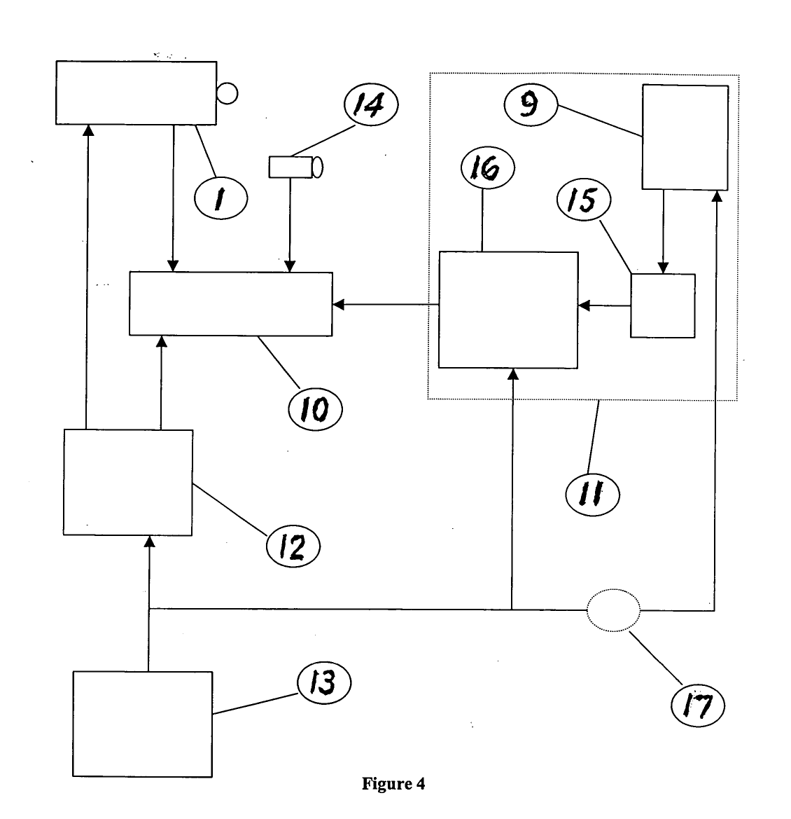

FIG. 3 illustrates the rear view and how the components are housed within the enclosure. The inside of the enclosure 6 is divided into three sections with the top shelf providing the entrance to the system for the coin/token mechanism 9 and the video recording sub-system 10. The middle section includes the control panel 11 and the power inverter 12. The bottom section houses the power supply unit (battery) 13.

1. An automated, video recording device comprising, in combination, the following:
a) a video camera;
b) a means for accepting token or monetary payment;
c) a means for enabling a switch following a preset amount of time;
d) a means for recording video;
e) a controller for programming said means for recording video;
f) a means for powering said video recording device;
g) an enclosure.

2. A device as described in claim 1 wherein said means for recording video functions are controlled in whole or in part by commands transmitted to it via infrared signals.

3. A device as described in claim 1 wherein enabling operation of said device is in response to said means for accepting token or monetary payment.

4. A device as described in claim 1 wherein said enclosure is composed of weather resistant material.

5. An automated, audio recording device comprising, in combination, the following:
a) an audio microphone;
b) a means for accepting token or monetary payment;
c) a means for enabling a switch following a preset amount of time;
d) a means for recording audio;
e) a controller for programming said means for recording audio;
f) a means for powering said audio recording device;
g) an enclosure.

6. A device as described in claim 5 wherein said means for recording audio functions are controlled in whole or in part by commands transmitted to it via infrared signals.

7. A device as described in claim 5 wherein enabling operation of said device is in response to said means for accepting token or monetary payment.

8. A device as described in claim 5 wherein said enclosure is composed of weather resistant material.
